(19) United States
(12) Patent Application Publication
(10) Pub. No.: US 2019/0228348 A1
(43) Pub. Date: Jul. 25, 2019

(54) RESERVATION SYSTEM IN A SHARED WORKSPACE

(71) Applicant: WeWork Companies Inc., New York, NY (US)

(72) Inventors: Kyle Philip O'Keefe-Sally, Brooklyn, NY (US); Emiliano Burgos, Brooklyn, NY (US); Joshua James Emig, Cold Springs, NY (US); Jocelyn Masserot, New York, NY (US); Gregg John Meyer, Brooklyn, NY (US); Maria Soledad Medina, Astoria, NY (US); Cole Smith, New York, NY (US); Brandon Scot McGregor, Long Island City, NY (US); Ubin Malla, New York, NY (US); Alan Edward Jackson, Bronx, NY (US)

(21) Appl. No.: 16/250,983

(22) Filed: Jan. 17, 2019

Related U.S. Application Data
(60) Provisional application No. 62/618,588, filed on Jan. 17, 2018.

(51) Int. Cl. G06Q 10/02; G06F 1/28

(52) U.S. Cl. CPC G06Q 10/02; G06F 1/28

(57) ABSTRACT

Systems and methods for facilitating reservations of shared desks, phone booths, and other spaces or areas within a workspace for members of the workspace are described. For example, a space reservation system receives a request to reserve a space for a member and selects a space suitable for the member based on one or more work environment characteristics associated with the space. The system also presents various interfaces for displaying available spaces and facilitating interactions between the member and the space.

### CROSS-REFERENCE TO RELATED APPLICATIONS

This application claims priority to U.S. Provisional Patent Application No. 62/618,588, filed on Jan. 17, 2018, entitled USER CUSTOMIZABLE WORKSPACE AND PHONE BOOTH, which is incorporated by reference in its entirety.

### BACKGROUND

Coworking and other shared workspaces offer members many benefits lacking in traditional office environments—flexible space use and support, diverse and vibrant communities of members, engaging activities and events, and so on. These shared workspaces provide limitless layouts of spaces and areas, including private offices, conference rooms, common areas, kitchens, phone booths, and private and shared desks.

A workspace can achieve such flexibility when providing a large area of common or shared spaces, such as shared desks, phone booths, and so on. These common or shared spaces act to balance the needs of members to find private or quiet spaces at certain times within the coworking environment. However, at times, issues may arise in effectively and efficiently providing such spaces to members of a workspace or shared community.

### BRIEF DESCRIPTION OF THE DRAWINGS

Embodiments of the present technology will be described and explained through the use of the accompanying drawings.

FIG. 1 is a block diagram illustrating a suitable computing environment for facilitating reservations of spaces within a workspace.

FIGS. 2A-2C are diagrams illustrating an example shared desk within a workspace.

FIG. 3 is a flow diagram illustrating a method for reserving a desk within a workspace.

FIGS. 4A-4F are display diagrams illustrating various example user interfaces presented by a desk reservation system.

FIG. 5 is a flow diagram illustrating a method for reserving a phone booth within a workspace.

FIGS. 6A-6F are display diagrams illustrating various example user interfaces presented by a booth reservation system.

The drawings have not necessarily been drawn to scale. Similarly, some components or operations may be separated into different blocks or combined into a single block for discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

### Overview

Systems and methods for facilitating the reservation of shared or common spaces or areas, such as desks and phone booths, within a workspace are described. The systems and methods can facilitate the matching of a member to a work area, such as a desk, that provides the member with a desired work environment or experience. For example, some types of workspaces or areas (e.g., shared or common desks) are always available (e.g., there are more desks than members wanting a desk), and the systems and methods facilitate the selective pairing of these types of spaces or areas to members.

Further, the systems and methods can facilitate the use of or access to phone booths, conference rooms, and other private, quiet, or specialized use areas or spaces. For example, these types of spaces can be in demand within a workspace (e.g., having fewer phone booths than members needing to use phone booths at any given time), and the systems and methods manage the access and reservation of these types of spaces for the members of the workspace.

The systems and methods also enable desks and phone booths (and other similar spaces) to act as peripheral devices to mobile devices associated with members of a workspace. For example, the systems and methods can control the activation of physical space (e.g., services provided by a desk or phone booth) upon the performance of certain actions by members within the space. Also, the systems and methods facilitate the pairing of mobile devices to interface devices of desks and phone booths, enabling members to seamlessly move between different areas of a workspace, among other benefits.

Various embodiments and implementations of the systems and methods will now be described. The following description provides specific details for a thorough understanding and an enabling description of these embodiments/implementations. One skilled in the art will understand, however, that these embodiments/implementations may practice fewer than all of these details. Additionally, some well-known structures or functions may not be shown or described in detail, to avoid unnecessarily obscuring the relevant description of the various embodiments/implementations. The terminology used in the description presented below is intended to be interpreted in its broadest reasonable manner, even though it is being used in conjunction with a detailed description of certain specific embodiments/implementations.

### Examples of a Suitable Computing Environment Provided by a Workspace

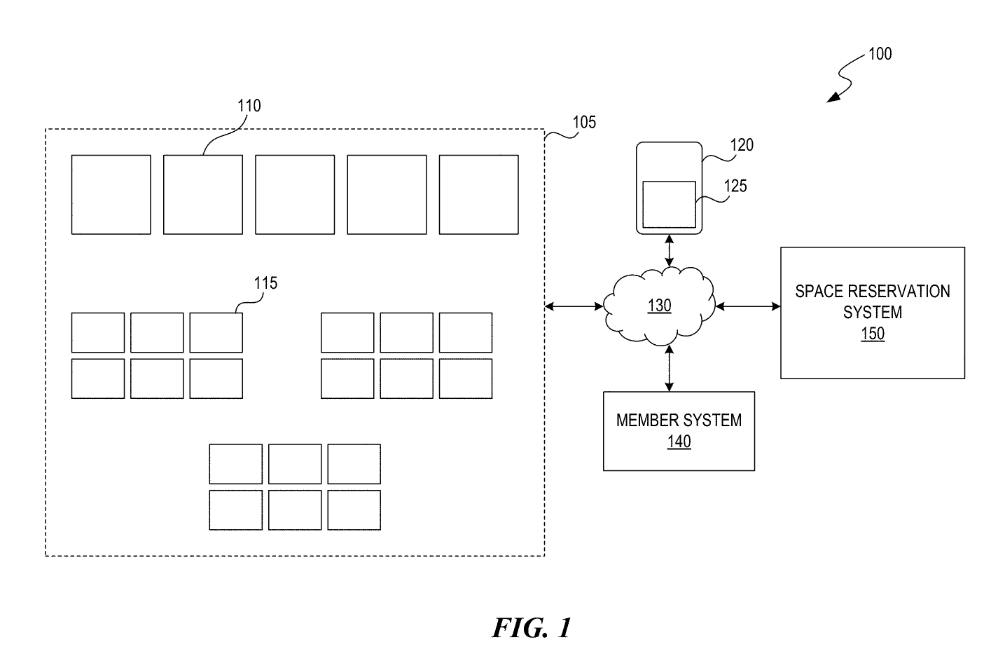

As described herein, the systems and methods enable members of a workspace to reserve and access different shared or common areas or spaces, such as shared desks, phone booths, conference rooms, and so on. FIG. 1 is a block diagram illustrating a suitable computing environment 100 for facilitating reservations of spaces within a workspace.

The computing environment 100 facilitates the exchange of data and information between a workspace 105 and a space reservation system 150, such as a system that performs the various operations or processes described herein. The workspace 105 includes different shared areas or spaces, including phone booths 110, shared desks 115, and other similar types of spaces (e.g., conference rooms, shared tables or seating areas, and so on).

The workspace 105 can also include other types of spaces, including private offices or areas, kitchens, pantries, help desks, entry points, bathroom facilities, lounges, industry-specific spaces (e.g., maker spaces, studios, lab or computing spaces), and so on. Thus, although FIG. 1 depicts the space reservation system 150 as exchanging data with shared desks 115 and phone booths 110, the system 150 can also perform various operations concerning any other area or space within the workspace 105.

The phone booths 110 and/or shared desks 115 include certain components or devices to exchange data with the system 150 via a network 130. For example, the booths 110 or desks 115 can include wireless beacons, Bluetooth components, wireless transceivers/components, or other devices or components configured to communicate over a network, such as the Internet or within a private network.

Further, the workspace 105 can include various components, sensors, devices, and so on, that function to collect data associated with managing the workspace 105 and optimizing or modifying its operations. For example, the workspace 105 can include various sensors to gather environmental data, including temperature via a network connected temperature sensor, noise levels via a network connected microphone, activity levels via one or more network connected motion sensors, light levels via one or more network connected image sensors, and so forth.

A member of the workspace 105 can access the network 130 via an associated mobile device 120, such as a smartphone, tablet, laptop, and so on. The mobile device 120 can include a mobile application 125, such as an application provided by the workspace 105 and configured to facilitate and enhance communications or actions of the member within the workspace 105. As described herein, the mobile application 125 can manage or assist in authorizing the member to use the workspace 105, can facilitate check-in actions for the member, can present information about the workspace 105 (e.g., layout information, operating information, event information, resources access, ordering actions, and so on), etc.

Thus, in some implementations, a member of the workspace 105 may send a request to reserve a phone booth 110 or shared desk 115 via his/her mobile device 120. The system 150 receives the request and performs various operations described herein to manage and handle the request.

The space reservation system 150 can access a member system 140 when handling requests or performing actions for members. The member system 140 stores information for members, such as biographical information, information about member access rights, electronic addresses for members (phone number, email address, etc.), historical information about member usage of the workspace 105 (or other workspaces associated with the workspace 105), information about member connections or contacts, and any other information associated with providing context about a work environment or experience desired or requested by the member.

Thus, in some implementations, the space reservation system 150 facilitates the reservation of different spaces (e.g., phone booths 110 or shared desks 115) within the workspace 105 on behalf of members of the workspace 105, in order to optimize the use of the workspace 105 with respect to the work experiences sought by members within the workspace 105, among other benefits.

FIG. 1 and the discussion herein provide a brief, general description of the components of the network environment 100. Although not required, aspects of the network environment 100 are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices (including tablet computers and/or personal digital assistants (PDAs)), all manner of cellular or mobile phones, (e.g., smartphones), multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein and refer to any of the above devices and systems, as well as any data processor.

Aspects of the environment 100 can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the environment 100 may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the system reside on a server computer, while corresponding portions reside on a client computer such as a mobile or portable device, and thus, while certain hardware platforms are described herein, aspects of the system are equally applicable to nodes on a network. In an alternative embodiment, a mobile device or portable device may represent the server portion, while the server may represent the client portion.

### Examples of Reserving Spaces for Members of a Workspace

As described herein, the space reservation system 150 includes various modules or components that function to facilitate the exchange of data with phone booths and shared desks and to perform various operations or processes for reserving access or use of the phone booths and shared desks on behalf of members.

For example, the space reservation system 150 performs various operations concerning a shared desk, such as one or more of the shared desks 115. A shared desk, as described herein, is a desk generally unassigned to any member of the workspace 105 when the desk is not in use (contrast this with a private desk, which is generally associated with a single member, regardless of whether it is in use). Thus, one member of the workspace 105 can utilize a particular shared desk on a Monday, and another member can utilize the desk on a Tuesday.

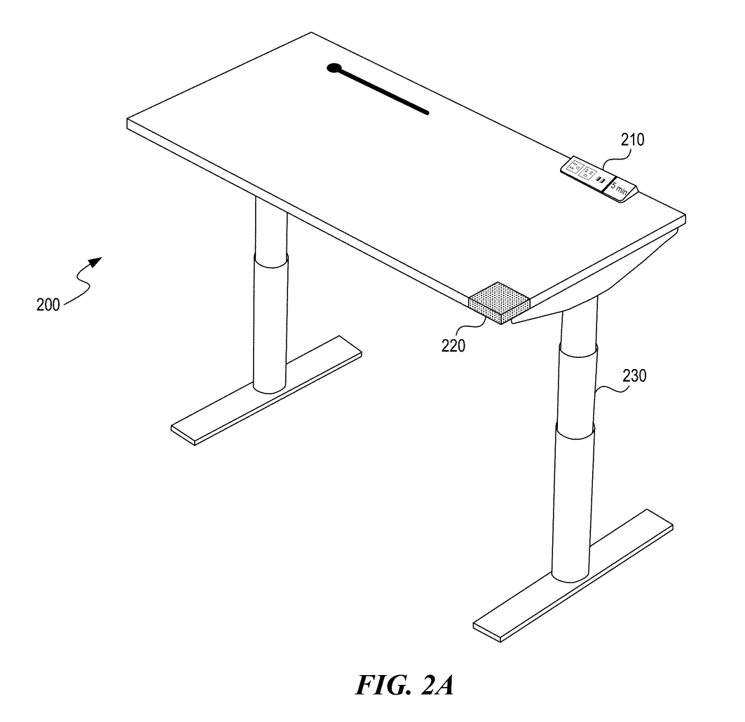

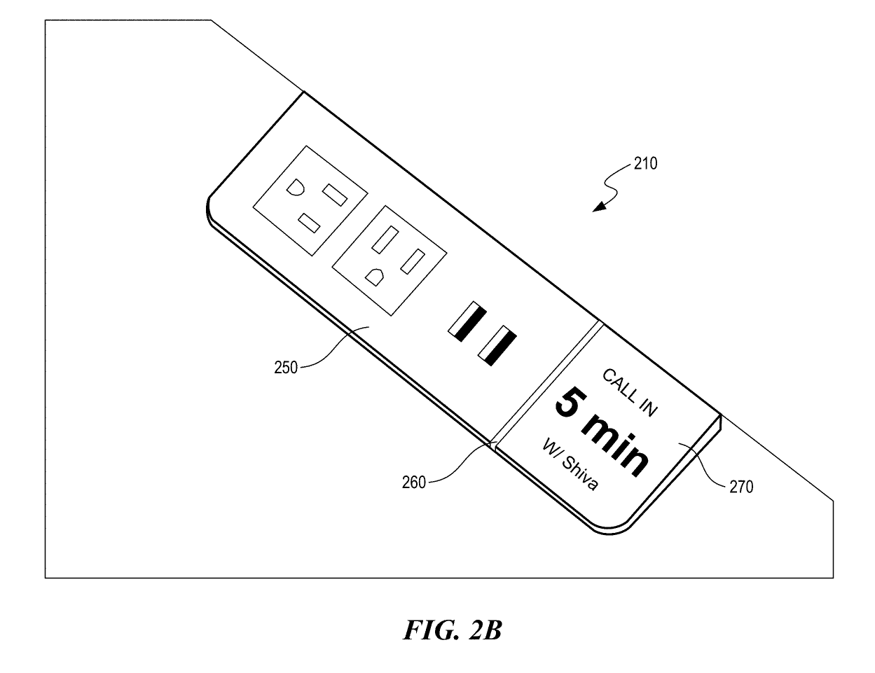

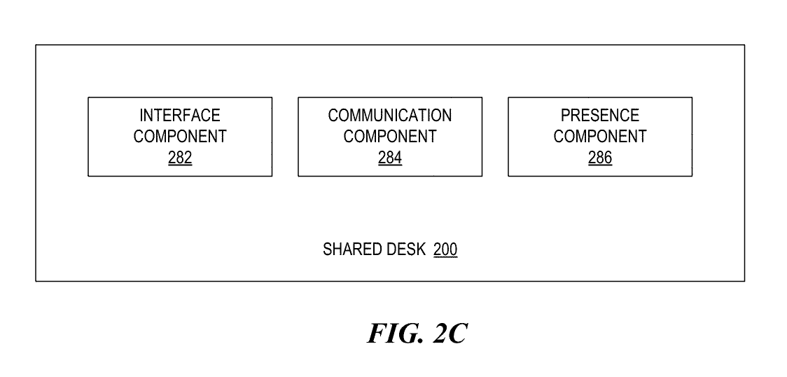

A shared desk can be a simple desk or can include various components that facilitate communications between the desk and the system 150, that interact with other sensors or capture devices within the workspace 105, and/or that perform operations to automatically adjust or reconfigure the desk based on the member assigned to the desk. FIGS. 2A-2B are diagrams illustrating an example shared desk 200 within a workspace.

As depicted in FIG. 2A, the shared desk 200 includes an interface component 210, which provides certain functionality for a member assigned or paired to the desk, such as power, information, status indicators, and so on. For example, FIG. 2B depicts an example interface component 210, including a power station or module 250 (providing USB and other sockets), a status indicator 260 (e.g., lights that change based on whether the desk 200 is in use, reserved, or available), a user interface 270, which presents information to the member associated with his/her schedule, information about the workspace 105, and so on.

Returning to FIG. 2A, the shared desk 200 also includes a handset or communication component 220. The handset 220 includes various devices that facilitate exchanges of information between the desk 200 and other devices or systems, such as the space reservation system 150 or the mobile device 120 associated with the member. Thus, the handset 220 can include a communication beacon (e.g., iBeacon), Bluetooth devices, RFID reader, wireless component or radio, and so on.

Further, the shared desk includes an adjustment component 230 configured to automatically adjust the height or position of the desk 200, to provide a physical configuration of the desk 200 suitable for the member paired to the desk 200. Thus, the adjustment component 230 can include a motor or other actuator that facilitates the translation or rotation of the desk 200 within 3D space.

Although not shown, the shared desk 200 can also include various sensors, including a presence sensor (e.g., a long-range depth sensor, motion sensor facing toward a front of the desk, a pressure sensor to sense weight on the desk) that detects the presence of a member at the desk, various environmental sensors (e.g., noise or audio sensors, temperature sensors, light level sensors, image sensors, vibration sensors, movement sensors, and so on).

Thus, FIG. 2C depicts a shared desk 200 with various integrated components. Such components may include functional modules or systems that are implemented with a combination of software (e.g., executable instructions, or computer code) and hardware (e.g., at least a memory and processor). Accordingly, as used herein, in some examples a module or system is a processor-implemented module, system, or set of code and represents a computing device having a processor that is at least temporarily configured and/or programmed by executable instructions stored in memory to perform one or more of the particular functions that are described herein.

For example, the shared desk 200 includes an interface component 282 that provides various power and interface services to the member (as described herein), a communication component 284 that facilitates the exchange of data and information between the desk 200 and the network 130, and a presence component 286 that determines when a member is working at the desk (or otherwise using the desk).

Thus, the shared desk 200 is configured to determine or capture data associated with a work environment surrounding the desk (e.g., where an environment is defined by noise, light, and/or temperature levels around the desk), transmit the data to the system 150 via one or more communication components, receive data from the system 150 (or from the mobile device 120), and perform actions to adjust a physical configuration of the desk 200, display information for the member (e.g., acting as a peripheral to the mobile device 120), display information identifying a status of the desk 200, and so on.

Further, other spaces, areas, or furniture within the workspace 105 can include similar components to those depicted concerning the shared desk 200. For example, phone booths 110 can also include presence sensors, power modules, communication components, and user interfaces. Further, the phone booths 110 can include additional configurable physical components, such as configurable lighting, displays, benches, desks or table tops, internal temperature components (e.g., thermometer electrically connected to the member system 140, thermostat), noise canceling devices, and so on.

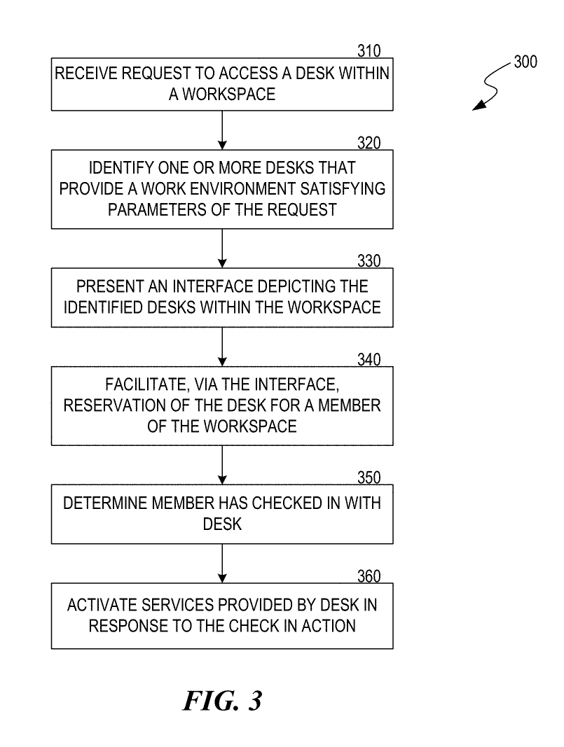

As described herein, the space reservation system 150 performs various operations or processes when selecting and/or reserving a shared desk for a member of the workspace 105. FIG. 3 is a flow diagram illustrating a method 300 for reserving a desk within a workspace. The method 300 may be performed by the space reservation system 150, and, accordingly, is described herein merely by way of reference thereto. It will be appreciated that method 300 may be performed on any suitable hardware.

In operation 310, the space reservation system 150 receives a request to access a desk, such as one of the shared desks 115, within a workspace. For example, the system 150 may receive input from a member provided via the member application 125 of the member's mobile device 120.

In some cases, the request includes various information provided by the member (e.g., duration of use for the desk, type of desk, geographical or internal location of the desk), as well as parameters or attributes desired by the member and stored within the system 150 or accessible by the system 150 (e.g., stored in the member system 140). For example, the request can include context information for the member and/or the request, such as information identifying previous desks utilized by the member, a type of work environment desired by the member, a location that includes certain other members within the workspace 105 (e.g., colleagues or friends of the member), and so on.

In operation 320, the space reservation system 150 identifies one or more desks available to provide a work environment that satisfies parameters within the request. The system 150 can review a database of all desks within the workspace 105, and selects desks having current or fixed characteristics that match a work environment requested by the member.

For example, the system 150 can track various characteristics or parameters applied to a desk within a workspace. These characteristics or parameters can be dynamically determined, as well as updated or modified over time. Example characteristics include: current noise levels at or around a desk, current light levels at or around a desk, current activity levels at or around a desk, current temperature at or around a desk, and so on. While not shown, the workspace 105 includes various sensors to gather environmental data, including temperature via a network connected temperature sensor, noise levels via a network connected microphone, activity levels via one or more network connected motion sensors, light levels via one or more network connected image sensors, and so forth.

In some cases, using various measured parameters, the system 150 can categorize a desk as providing certain work environments or experiences. For example, a desk in a back corner of a room and/or having a low lighting level parameter and a low noise level parameter can provide a “quiet and calm” work environment, whereas a desk located near an elevator or shared space and/or having a high noise level parameter and high activity level parameters, can provide a “social” work environment. The space reservation system 150 stores data regarding attributes and categorizations of desks and other resources within the workspace 105.

Further, the system 150 can also categorize a desk based on its location within a workspace concerning the locations of other members of the workspace. For example, the system 150 can access information identifying one or more friends or colleagues of the member and selects desks that are proximate to these identified friends or colleagues within the workspace. The member system 140 stores data regarding colleagues or connections between members to facilitate space reservation, including, in some cases, connections between members via one or more social media sites or services.

In operation 330, the space reservation system 150 presents an interface depicting the identified desks within the workspace 105. For example, the system 105 renders and displays a map of a layout of a workspace via an interface of the mobile application 125, and highlights, via various graphical elements, available desks that satisfy the request.

In operation 340, the space reservation system 150 facilitates a reservation of one of the identified desks for the member. For example, the member can select a desk identified as available via the mobile application 125, and the system 150, in response to the selection, reserves the desk for the member. In some cases, the system 150 can automatically reserve one of the identified desks suitable to the member without receiving input from the member. The space reservation system 150 maintains a database reflecting all desks, phone booths, conference rooms and other resources provided in the workspace 105, as well as parameters are attributes of all resources within the workspace, and likewise maintains calendaring data for coordinating reservation of such resources as described herein.

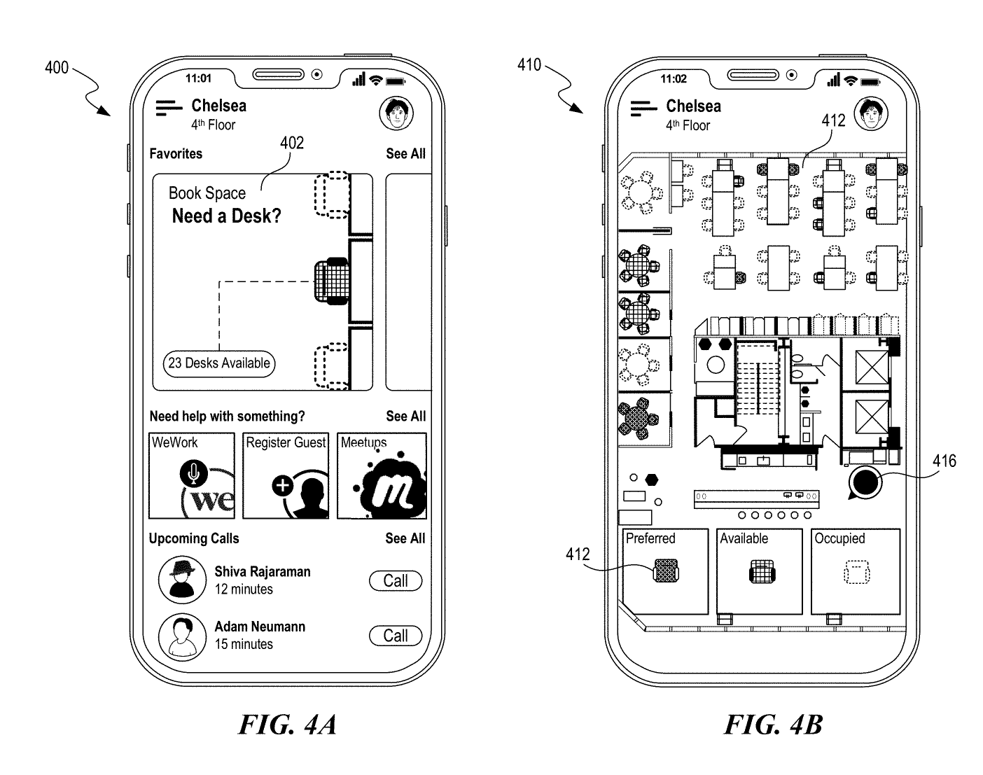

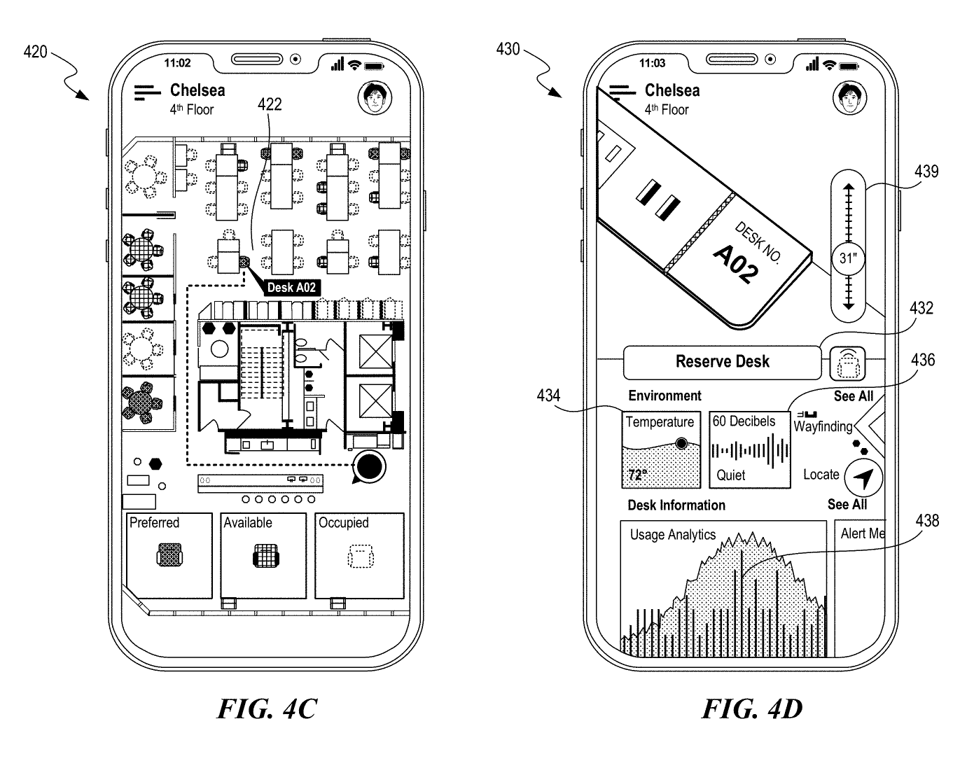

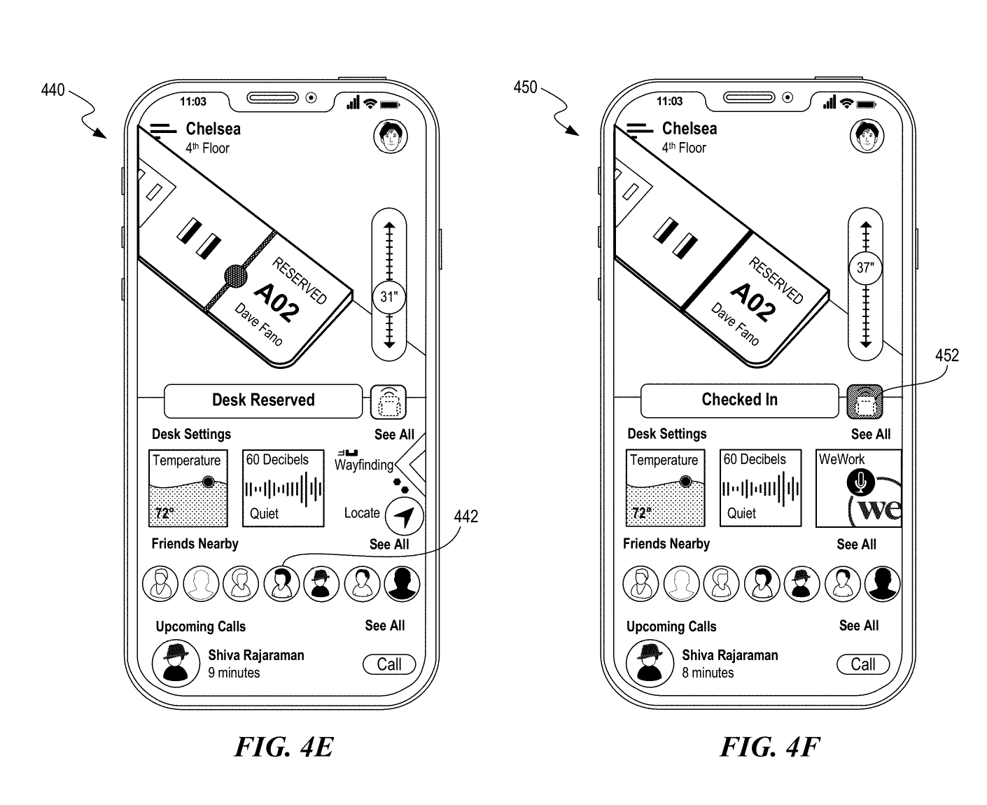

FIGS. 4A-4F depict various example user interfaces presented to the member when reserving a shared desk via the system 150. In FIG. 4A, a member access a “need a desk” module 402 depicted via interface 400 and provided by the member mobile application 125.

Once the module 402 is selected, the mobile application 125, as depicted in FIG. 4B, presents interface 410. The interface 410 presents a layout 412 of the workspace, highlighting desks by their status 414, as well as a position 416 of the member within the space. For example, the interface 410 identifies desks “preferred” by the member, “available” to the member, or currently “occupied,” such as by color coding each desk based on its status.

FIG. 4C presents an interface 420, which presents a desk 422 that is preferred by the member. As described herein, the system 150 can determine the desk 422 is preferred based on different parameters or contexts, as well as on historical use of the workspace by the member.

Once the member selects the desk 422, the mobile application 125, as depicted in FIG. 4D, presents an interface 430 that presents details about the specific desk 422. First, the interface 430 includes a user-selectable component 432 configured to facilitate reservation of the desk by the user. Also, the interface 430 presents work environment information associated with the desk, including temperature information 434, noise level information 436, usage information 438, and so on. The interface also includes a height adjustment element 439 that can present a current height of the desk and facilitate input by the member to adjust the height of the desk, if so desired.

In FIG. 4E, once the desk is reserved, an interface 440 presents additional information about the work environment, such as information 442 identifying other members 442 near or at a location that includes the desk. Finally, in FIG. 4F, an interface 450 includes a user-selectable element 452 that facilitates the member checking into the desk, which enables the system 150 to confirm the desk is assigned to the member and in use.

The check-in action performed by the member can cause the performance of various additional actions. Returning to FIG. 3, the space reservation system 150, in operation 350, determines a member has performed a check in operation with a shared desk, and, in operation 360, activates services provided by the desk in response to the check-in operation. For example, the desk may restrict the use of the power module 250 or display components 270, or not be reconfigured, until the member checks in with the desk (also, in some cases, pairing his/her mobile device with the desk). Thus, in some implementations, the space (via the desk) provides services only after the member checks into the desk and commences use of the desk.

In some cases, the member can utilize a single sign-on (SSO) action when performing the check-in operation at the desk. Example SSO actions include waving of an RFID keycard at a sensor at the desk, providing mobile credentials, biometric information, or other single or multi-factor authentication information. The single sign-on action enables the desk to receive identity information for the member, as well as presence information, which authorizes the member to receive services provided by the desk and the workspace 105. Thus, in some cases, once a shared desk is provided an identity (such as a member identity), the workspace 105 can provide a seamless and consistent interaction with the member across various areas (e.g., desks, phone booths, conference rooms) or services (e.g., mail, laundry, food ordering, printing, guest registration).

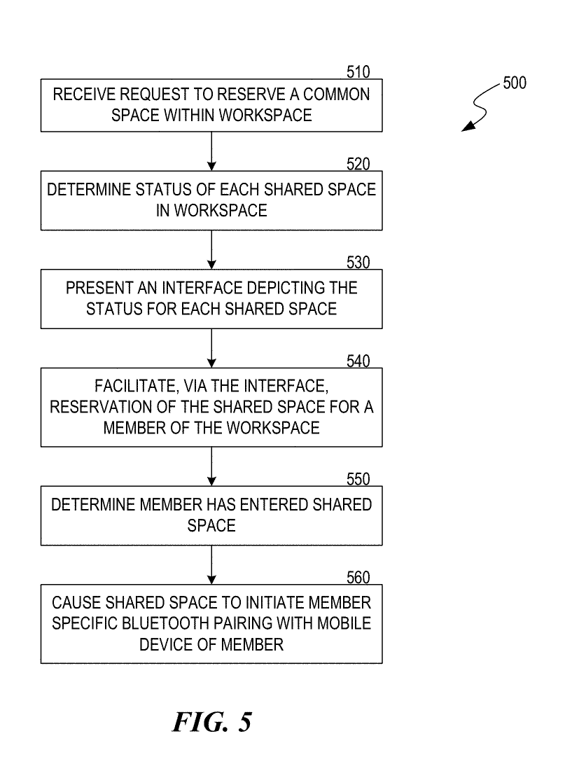

As described herein, the space reservation system 150, in some implementations, facilitates the access by members of certain spaces (e.g., phone booths 110 and conference rooms) that are in great demand within the workspace 105. FIG. 5 is a flow diagram illustrating a method 500 for reserving a phone booth within a workspace. The method 500 may be performed by the space reservation system 150, and, accordingly, is described herein merely by way of reference thereto. It will be appreciated that the method 500 may be performed on any suitable hardware.

In operation 510, the space reservation system 150 receives a request to reserve a common space (e.g., phone booth, conference room, another shared area) from a member. For example, the system 150 may receive input from a member provided via the member application 125 of the member's mobile device 120. The input may include a time at which to reserve the space (e.g., “now” or “at 3 PM”), as well as other information that identifies the reason for the reservation (e.g., a phone call or meetings), the number of members associated with the request (e.g., one or a group), and so on.

In operation 520, the space reservation system 150 determines the status of each shared space within the workspace 105. For example, the system 150 accesses various systems that monitor real-time or scheduled use of the workspace 105, to determine what spaces are available and/or predict when the spaced will next be available.

In operation 530, the space reservation system 150 presents an interface depicting a status of each common space within the workspace 105. For example, the mobile application 125 presents a layout of all phone booths within the space, as well as color indicators that identify a status of each of the phone booths and information identifying current and predicted usage of the phone booths.

In operation 540, the space reservation system 150 facilitates the reservation of a common space for the member. For example, via the interface presented by the mobile application 125, the system 120 can receive input from the member and reserve a booth for a certain future time period, perform an immediate reservation of a phone booth, or place the member in a queue of members waiting to use one of the phone booths within the workspace 105.

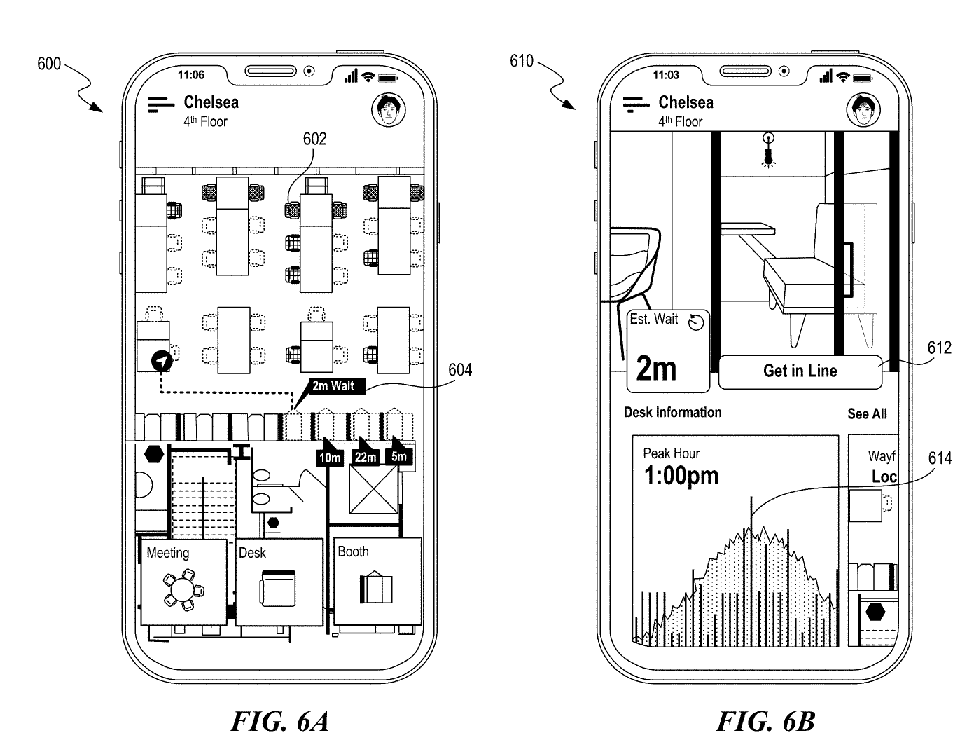

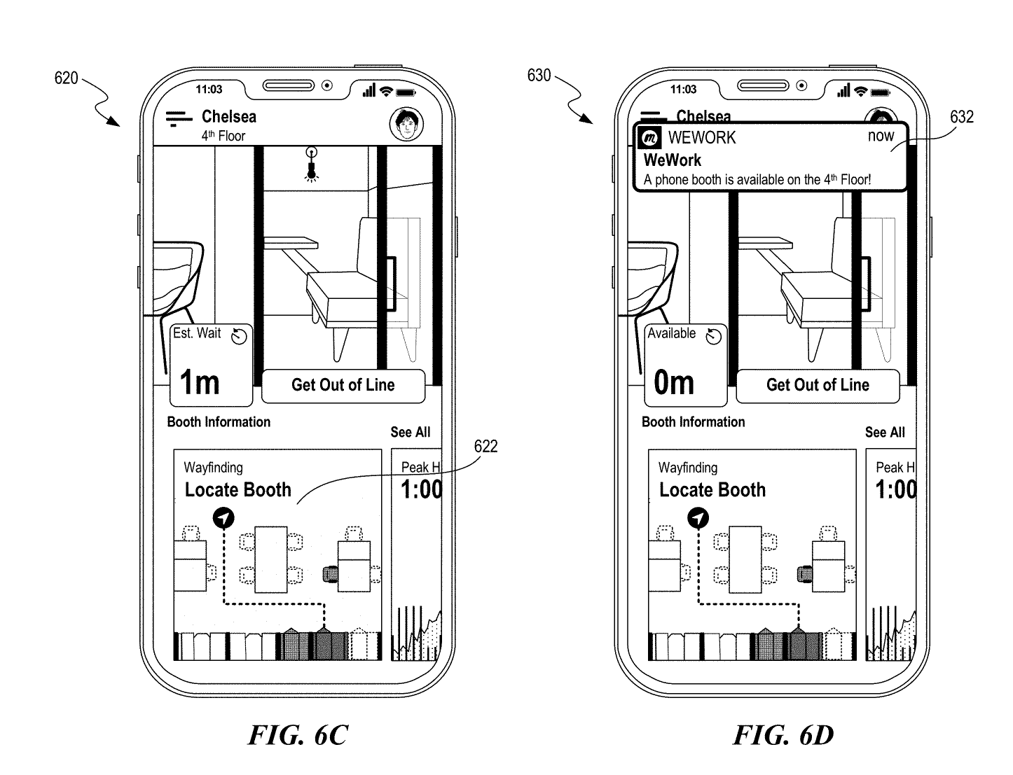

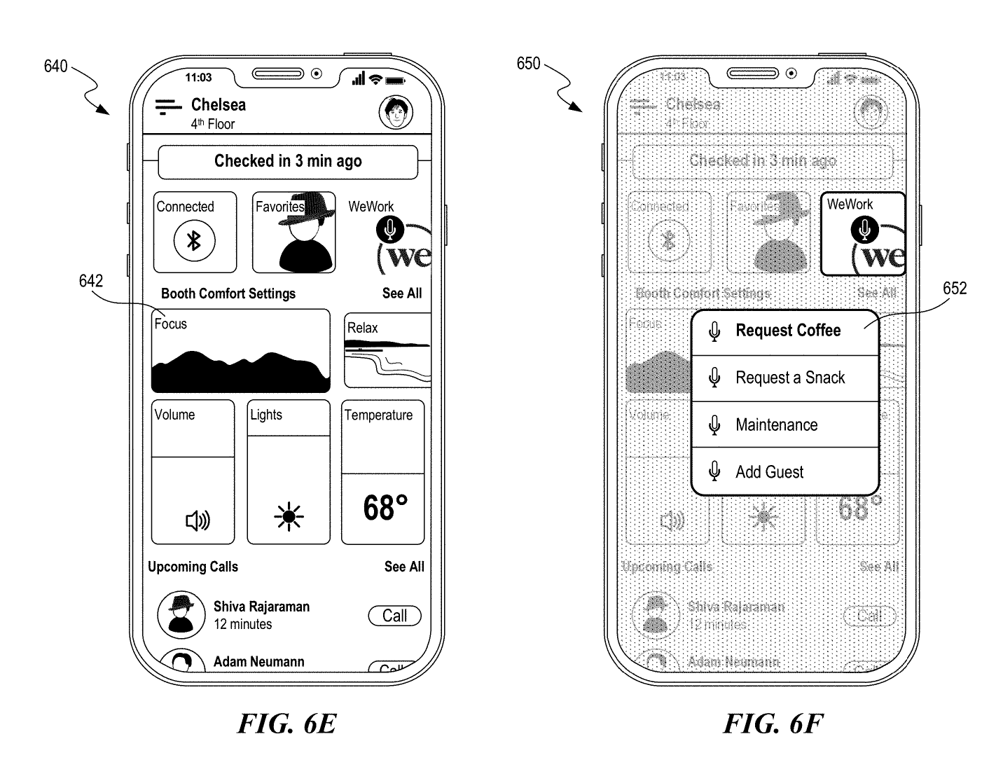

FIGS. 6A-6F depicts various example user interfaces presented by a booth reservation system. In FIG. 6A, an interface 600 presents a layout 602 of the workspace 105 and highlights phone booths 604 to be reserved by the member. The interface 600 presents waiting period times for each of the phone booths, determined by the system 150 based on historical usage or patterns of the booths or knowledge of ongoing use of the booths by other members (e.g., knowledge of when current reservations are ending).

FIG. 6B depicts an interface 610, which presents details about a specific phone booth and a user-selectable element 612 to reserve the phone booth (or be added to a waiting list). For example, the interface 610 displays an estimated wait time, usage trend information 614, and so on.

In some cases, the system 150 determines another phone booth is a better match for the member (e.g., has a lower estimated wait time or is closer to the member's location), and presents, as depicted in FIG. 6C, an interface 620 to select the other phone booth. The interface 620 includes wayfinding information 622 and other details (e.g., estimated wait time) for the booth. Similarly, as depicted in interface 630 of FIG. 6D, the system 150 can notify 632 the member when a phone booth is available for use.

FIGS. 6E and 6F present interfaces 640 and 650, respectively, that depict the integration of various services provided by the workspace 105 via a phone booth or other common space. For example, as presented in interface 640, the mobile application 125 acts to provide the member with various actions 642 to be performed by the phone booth 110, such as modifying lighting or use of various components (e.g., video displays or audio) as peripherals for the mobile device 120. In some cases, once the mobile application 125 is paired to the phone booth (such as Bluetooth pairing), the mobile device 120 can render an icon that presents the booth as a paired device (similar to other icons presented by the OS of the mobile device 120).

Further, as shown in interface 650, the member can perform other actions, such as order coffee 652, add guests, and so on, via a common, shared experience. Thus, the workspace 105, via integration (e.g., full-stack integration) of different devices spaces, and services enables the member to experience a consistent and seamless experience within the workspace 105, regarding of the specific area or space at which they are located.

Although the interfaces depict the placement of the member in a queue for a single phone booth, other implementations may utilize a common or combined queue for some or all phone booths (or, conference rooms) within a workspace 105. Unlike desks, phone booths are indistinguishable from one another, and are only used temporarily by a member (e.g., for a 30-minute phone call), and, thus, a member may not care to use a specific phone booth when another booth becomes available.

Similar to check-in actions with shared desks, the performance of a check-in action (or other access) with respect to a common space can trigger certain actions performed by the common space (or, by devices of the common space). Returning to FIG. 5, the space reservation system 150, in operation 550, determines a member has performed a check in operation with a shared or common space (or otherwise entered), and, in operation 560, causes the shared space to initiate a member-specific Bluetooth pairing with the mobile device 120 of the member.

For example, the phone booth (or conference room) determines the member has commenced use of the space and initiates Bluetooth pairing that is only advertised to the mobile device of the member, in order to facilitate an efficient and seamless pairing between the mobile device and various devices of the phone booth. The phone booth (or other databases of the system 150) stores pairing information from previous use of the phone booth, and, upon the member's check-in, advertises to the mobile device for current pairing.

In another example, the phone booth or conference room (collectively, shared room) receives a wireless signal from the member's mobile device and automatically configures the shared room for specific use by that member. The wireless transceiver in or near the shared room receives a wireless signal from the member's mobile device (e.g. smart phone) where that wireless signal can be a Bluetooth signal or a 4G/5G signal, etc., where that signal includes an identifier uniquely identifying the member (Bluetooth ID, mobile phone number, etc.). When the system receives this unique identifier at or near the shared room, the system accesses the member system 140 to retrieve member preferences and automatically configures the shared room based on those preferences. Further, the system automatically pairs the member's mobile device to resources in the shared room, such as a speakerphone, videoconferencing system, and so forth. Moreover, the shared room can automatically poll for a wireless connection to the member's laptop to connect the laptop with, for example, a display monitor or with a display projector to permit the user to present a slide presentation via the display projector within the shared room. Once the time for the meeting expires, the system can cease all wireless connections with the member's devices (and can provide a warning to the member before closing wireless connections). Wireless connections to other devices are possible, such as to a two-dimensional printer, a three-dimensional or additive printer, a high-fidelity audio system, a virtual reality or augmented reality headset, etc.

### Conclusion

Unless the context clearly requires otherwise, throughout the description and the claims, the words “comprise”, “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein”, “above”, “below”, and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in the text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments but also all equivalent ways of practicing or implementing the disclosure under the claims.

From the preceding, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A non-transitory computer-readable medium whose contents, when executed by a computing system, cause the computing system to perform a method, the method comprising:
receiving an identifier associated with a member of a workspace;
authorizing the member to access the workspace;
determining the member has performed a check-in operation at a desk within the workspace; and
activating one or more services provided by the desk in response to the check-in operation.

2. The non-transitory computer-readable medium of claim 1, further comprising:
before receiving the identifier associated with the member of the workspace, receiving a request from the member to reserve a shared desk within the workspace;
determining the desk is a shared desk that provides a work environment matching a work environment suitable for the member; and
reserving the desk within the workspace on behalf of the member.

3. The non-transitory computer-readable medium of claim 1, wherein the identifier is received via a RFID card reader of the desk that reads the identifier from an RFID card associated with the member.

4. The non-transitory computer-readable medium of claim 1, wherein activating one or more services provided by the desk in response to the check-in operation includes activating a user interface of the desk that presents information targeted to the member in response to the check-in operation.

5. The non-transitory computer-readable medium of claim 1, wherein activating one or more services provided by the desk in response to the check-in operation includes activating a power module that provides power to electronic devices in response to the check-in operation.

6. The non-transitory computer-readable medium of claim 1, wherein activating one or more services provided by the desk in response to the check-in operation includes activating a physical reconfiguration of the desk in response to the check-in operation.

7. The non-transitory computer-readable medium of claim 1, wherein activating one or more services provided by the desk in response to the check-in operation includes automatically adjusting a height of the desk that matches a desk height parameter associated with the member in response to the check-in operation.

8. The non-transitory computer-readable medium of claim 1, wherein the desk is a shared desk that is available to all members of the workspace.

9. At least one non-transitory computer-readable medium carrying instructions that, when executed by at least one data processor, perform a method, the method comprising:
determining that a user has accessed a shared room,
wherein the shared room is one of multiple shared rooms in a physical co-working location shared by multiple users;
receiving a wireless signal from a wireless mobile device carried by the user; and,
based on the wireless signal, automatically and temporarily reconfiguring parameters for the shared room.

10. The non-transitory computer-readable medium of claim 9, wherein the shared room is shared by the multiple users who are employed by different and separate companies, wherein each company is unrelated to the other companies, and wherein the determining is based on a prior reservation for one of the shared rooms made by the user via an app on the wireless mobile device.

11. The non-transitory computer-readable medium of claim 9, wherein the determining is based on detecting a proximity to the shared room by the user's wireless mobile device, and wherein the wirelessly connecting includes using a Bluetooth connection between the wireless mobile device and: a speakerphone, a videoconferencing device, a printer, an additive printer, a display device, an image projector, a high-fidelity audio system, a virtual reality headset or an augmented reality headset.

12. The non-transitory computer-readable medium of claim 9, wherein the automatically reconfiguring includes automatically adjusting a light level, temperature, or audio output level within the shared room.

13. The non-transitory computer-readable medium of claim 9, further comprising detecting a unique identifier transmitted by the wireless mobile device, and accessing a profile for the user associated with the unique identifier, and
wherein the automatically reconfiguring includes adjusting parameters of resources within the shared room based on user preferences in the profile.

14. The non-transitory computer-readable medium of claim 9, further comprising receiving a request to reserve one of the multiple shared rooms,
wherein the request is received via a graphical user interface presented to the user via the wireless mobile device, wherein the wireless mobile device is a smartphone, and wherein the request includes a date and time;
determining a status of each of the multiple shared rooms for the requested date and time;
depicting, via the graphical user interface, a depiction of each of the multiple shared rooms together with a graphical indication of a status of each of the shared rooms at the date and time; and
receiving, from the smartphone, a request to reserve one of the shared rooms.

15. The non-transitory computer-readable medium of claim 9, wherein the automatically reconfiguring includes adjusting environmental parameters within the shared room based on a stored profile for the user, and providing a wireless connection to a portable computer associated with the user, wherein the wireless connection connects the portable computer to a computer peripheral device within the shared room.

16. A method, comprising:
receiving a request from a member of a workspace to occupy a desk within the workspace,
wherein the request is received via a user interface presented by a mobile application associated with the workspace and running on a mobile device of the member;
identifying multiple candidate desks within the workspace that satisfy a work environment factor identified within the request; and
presenting the identified candidate desks to the member via a floorplan of the workspace displayed within the user interface of the mobile application.

17. The method of claim 16, further comprising:
receiving from the member and via the user interface a request to reserve one of the presented candidate desks; and
reserving the requested desks on behalf of the member.

18. The method of claim 16, wherein the request includes context information that identifies locations of other members of the workspace that are associated with the member; and
wherein identifying multiple candidate desks within the workspace that satisfy a work environment factor identified within the request includes identifying at least one shared desk at a location that includes the other members of the workspace that are associated with the member.

19. The method of claim 16, wherein the request includes context information that identifies a desired temperature profile for the member; and
wherein identifying multiple candidate desks within the workspace that satisfy a work environment factor identified within the request includes identifying at least one shared desk having a measured ambient temperature that satisfies the desired temperature profile of the member.

20. The method of claim 16, wherein the request includes context information that identifies a desired noise level for the member; and
wherein identifying multiple candidate desks within the workspace that satisfy a work environment factor identified within the request includes identifying at least one shared desk having a measured noise level that satisfies the desired noise level of the member.
